(19) United States
(12) Patent Application Publication
(10) Pub. No.: US 2012/0325331 A1
(43) Pub. Date: Dec. 27, 2012

(54) Pressure Regulator Valve Replacement Assembly

(75) Inventors: Todd V. Mangiagli, Putney, VT (US); Edward J. Lee, Chesapeake City, MD (US)

(73) Assignee: SONNAX INDUSTRIES, INC., Bellows Falls, VT (US)

(21) Appl. No.: 13/169,755

(22) Filed: Jun. 27, 2011

(51) Int. Cl. F16K 15/04

(52) U.S. Cl. 137/12; 137/528; 137/539

(57) ABSTRACT

A pressure regulator valve replacement assembly for maintaining a flow of transmission fluid to various fluid circuits within a Honda automatic transmission during low torque operation of a torque converter is disclosed. To accomplish this, the pressure regulator valve replacement assembly includes a valve piston subassembly having control diameters, and a valve chamber containing a check ball.

### FIELD OF THE INVENTION

The present invention generally relates to the field of pressure regulation in automotive transmissions. In particular, the present invention is directed to a pressure regulator valve replacement assembly.

### BACKGROUND

The transmission fluid used in automotive transmission systems is often pressurized using a positive displacement pump. That is, the pump delivers the same volume of transmission fluid to the fluid circuits within the transmission at every pump-cycle regardless of the volume of transmission fluid already within the fluid circuits. This may lead to over-pressurizing the transmission fluid such that it may damage valves or other components in fluid communication with the transmission fluid. Given this risk, the valves and components in fluid communication with the fluid circuit require protection from damaging fluid pressures.

The valves and components of the transmission may be protected using a pressure regulator valve. A typical pressure regulator valve diverts some of the automatic transmission fluid from the input fluid circuit to the transmission fluid pump reservoir, thereby bypassing the fluid circuits and reducing the pressure of the transmission fluid. However, some designs of pressure regulator valves may deprive critical components of needed transmission fluid at low values of torque transmitted by the torque converter or at low pressures of the transmission fluid. This deprivation may cause overheating of the transmission fluid, among other detrimental effects. Additionally, the deprivation of transmission fluid may also cause the engine to stall by preventing a lock-up clutch from disengaging at low torque converter torque values.

### SUMMARY OF THE DISCLOSURE

In one implementation, the present disclosure is directed to a pressure regulator valve assembly for maintaining a flow of automatic transmission fluid from an input fluid circuit to a torque converter fluid circuit and a transmission cooling fluid circuit of Honda Transmissions during low torque operation of a torque converter, the Honda Transmissions including a bore in fluid communication with the input fluid circuit, the torque converter fluid circuit and the transmission cooling fluid circuit. The pressure regulator valve assembly comprises a valve piston subassembly receivable in the bore in the transmission, said valve piston subassembly including a piston body coupled to a valve stem, said piston body having two terminal control diameters and at least one intermediate control diameter disposed between said two terminal control diameters, said at least one intermediate control diameter having an exterior surface in fluid communication with the bore when positioned in the bore, said valve piston subassembly including a valve chamber positioned substantially within said intermediate control diameter and configured to extend to said exterior surface so as to be in fluid communication with (i) said exterior surface and (ii) the bore when said valve piston subassembly is positioned in the bore; and a check ball disposed within said valve chamber so as to be movable between (i) a first position where said check ball is located so that said valve chamber is in fluid communication with the bore and hence the input circuit, the torque converter circuit, and the cooling circuit when the valve piston subassembly is positioned in the bore so that the automatic transmission fluid may be channeled from the input circuit to the torque converter circuit via said valve chamber and (ii) a second position where said check ball is located to occlude said valve chamber such that said valve chamber is not in fluid communication with the input circuit, whereby automatic transmission fluid is not channeled from the input circuit to the torque converter circuit.

In another implementation, the present disclosure is directed to a Honda Transmission modified to maintain a flow of automatic transmission fluid from an input fluid circuit to a torque converter fluid circuit and a transmission cooling fluid circuit during low torque operation of a torque converter. The Honda Transmission modified to maintain a flow of automatic transmission fluid comprises a bore; a pressure regulator assembly including: (i) a valve piston subassembly received in the bore in the transmission, said valve piston subassembly including a piston body coupled to a valve stem, said piston body having two terminal control diameters and at least one intermediate control diameter disposed between said two terminal control diameters, said at least one intermediate control diameter having an exterior surface in fluid communication with said bore, said valve piston subassembly including a valve chamber positioned substantially within said intermediate control diameter and configured to extend to said exterior surface so as to be in fluid communication with (i) said exterior surface and (ii) said bore; and (ii) a check ball disposed within said valve chamber so as to be movable between (i) a first position where said check ball is located so that said valve chamber is in fluid communication with the bore and hence the input circuit, the torque converter circuit, and the cooling circuit when the valve piston subassembly is positioned in the bore so that the automatic transmission fluid may be channeled from the input circuit to the torque converter circuit via said valve chamber and (ii) a second position where said check ball is located to occlude said valve chamber such that said valve chamber is not in fluid communication with the input circuit, whereby automatic transmission fluid is not channeled from the input circuit to the torque converter circuit.

In yet another implementation, the present disclosure is directed to a method of maintaining a flow of transmission fluid from an input fluid circuit to a torque converter fluid circuit and a transmission cooling fluid circuit of a Honda Transmission during low torque operation of a torque converter of the Honda Transmission. The method of maintaining flow of transmission fluid comprises providing a valve piston subassembly receivable in a regulator valve bore in the Honda Transmission, the valve piston subassembly including a piston body having two terminal control diameters and at least one intermediate control diameter disposed between the two terminal control diameters, the at least one intermediate control diameter having an exterior surface, the valve piston subassembly including a valve chamber positioned substantially within the intermediate control diameter and configured to extend to the exterior surface so as to be in fluid communication with (i) the exterior surface and (ii) the bore when said valve piston subassembly is positioned in the bore, the valve chamber including a check ball biased by a spring; and channeling the transmission fluid from the input fluid circuit to the torque converter fluid circuit and the cooling fluid circuit during low torque operation of the torque converter through the valve chamber positioned substantially within the intermediate control diameter, the transmission fluid from the input fluid circuit being provided at sufficient pressure to overcome the bias force from the spring on the check ball.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic circuit diagram of an exemplary embodiment of fluid circuits in communication with a pressure regulator valve and a torque converter;

FIG. 2 is a cross-sectional view of an embodiment of a pressure regulator valve, including a replacement assembly, in a configuration in which the replacement assembly is regulating pressurized transmission fluid;

FIG. 3 is a cross-sectional perspective view of an embodiment of a pressure regulator valve, including a replacement assembly, in a configuration in which the replacement assembly is regulating pressurized transmission fluid;

FIG. 4 is a cross-sectional view of an embodiment of a pressure regulator valve, including a replacement assembly, in a configuration in which the valve is maintaining transmission fluid flow through a valve chamber; and

FIG. 5 is a cross-sectional view of an embodiment of a pressure regulator valve, including a replacement assembly, that is exposed to un-pressurized transmission fluid.

### DETAILED DESCRIPTION

### General Description

Embodiments of the present invention disclosed herein include a pressure regulator valve replacement assembly that may maintain a flow of transmission fluid to a torque converter fluid circuit and a transmission fluid cooler circuit during operating conditions of a torque converter in which low values of torque are produced. Because of the wide variety of designs of torque converters and the difficulty of generalizing a torque range that produces the configurations discussed herein, this disclosure will instead describe transmission fluid pressure regimes resulting from the action of a torque converter. Those skilled in the art will appreciate that the pressures described may correspond to a wide range of torque values depending on the particular torque converter design and operating conditions.

Among other advantages, supplying transmission fluid to the foregoing circuits at fluid pressures may facilitate disengaging a lock-up clutch connected to the torque converter. Certain examples disclosed herein are particularly well suited for use with the following Honda transmission models: M24A Model Years 1993 to 1997, A4RA Model Years 1996, B4RA Model Years 1997 to 2000, M4RA Model Years 1997 to 1998, BMXA Model Years 2001 to 2005, SLXA Model Year 2001, MDMA Model Years 1996 to 2000, MDLA Model Years 1998 to 2004, M4TA Model Years 1997 to 2004, SDMA Model Years 1997 to 1999, SP7A Model Years 1994 to 1999, S4XA Model Years 1994 to 1999, SKWA Model Years 2000 to 2001, B7TA Model Years 1999 to 2001, B7VA 1999 Model Year, B7ZA Model Years 1996 to 2000, M7ZA Model Years 1996 to 2000, B7XA Model Years 1998 to 2002, BAXA Model Years 1998 to 2002, B6VA Model Years 1998 to 1999, MAXA Model Years 1998 to 2002, MDWA 1998 Model Year, M6HA Model Years 1997 to 2001, BZKA Model Years 2003 to 2010, MZKA Model Years 2003 to 2010, MCVA Model Years 1998 to 2004, MRVA Model Years 1997 to 2004, BCLA Model Years 2003 to 2007, MCLA Model Years 2003 to 2007, MZHA Model Years 2007 to 2010, MZJA Model Years 2007 to 2010, BZHA Model Years 2008 to 2010, BZJA Model Years 2008 to 2010, B90A Model Years 2008 to 2011, M91A Model Years 2008 to 2011, MCTA Model Years 2004 to 2007, MKYA 2005 Model Year, MKZA Model Years 2005 to 2006, GPLA Model Years 2005 to 2007, GPPA Model Years 2005 to 2007, MM7A Model Years 2009 to 2011, MRMA Model Years 2002 to 2006, SMMA Model Years 2007 to 2008, SP5A Model Years 2009 to 2010, MP5A Model Years 2009 to 2010, SPCA Model Years 2006 to 2010, MPCA Model Years 2006 to 2010, K4 Model Years 1988 to 1991, PY8A Model Years 1990 to 1991, L4 Model Years 1983 to 1991, L5 Model Years 1986 to 1990, MPWA Model Years 1992 to 1994, P36A Model Years 2007 to 2011, B36A Model Years 2007 to 2011, B97A Model Years 2008 to 2011, BDHA Model Years 2007 to 2011, BDKA Model Years 2003 to 2007, MDKA Model Years 2003 to 2007, BJFA Model Years 2006 to 2008, MJFA Model Years 2006 to 2008, BWEA Model Years 2007 to 2011, MJBA Model Years 2005 to 2007, MURA Model Years 2005 to 2006, P34A Model Years 2009 to 2011, P35A Model Years 2009 to 2011, PN3A Model Years 2009 to 2011, PN4A Model Years 2009 to 2011, PSFA Model Years 2009 to 2011, BAYA Model Years 2003 to 2007, MAYA Model Years 2003 to 2007, BDGA Model Years 2004 to 2008, BGFA Model Years 2001 to 2006, MGFA Model Years 2001 to 2006, B7WA Model Years 2001 to 2005, MGHA Model Years 2001 to 2002, BGHA Model Years 2001 to 2002, BGRA Model Years 2005 to 2007, PGRA Model Years 2005 to 2007, BVGA Model Years 2003 to 2007, PVGA Model Years 2003 to 2007, BVLA Model Year 2007, PVLA Model Years 2003 to 2007, and BYBA Model Years 2002 to 2004. This group of transmissions, each transmission in the group, and other Honda transmissions suffering from the problems motivating the present invention, are referred to in the claims as the “Honda Transmissions.” While these transmissions are identified, those skilled in the art will appreciate that the teachings of the present disclosure are not limited to these transmissions, nor limited to automotive transmissions generally. Indeed, the broad teachings of the present disclosure may be applied to any number of systems in which a pressure regulator valve is used to regulate fluid pressure to fluid circuits at a variety of operating transmission fluid pressures.

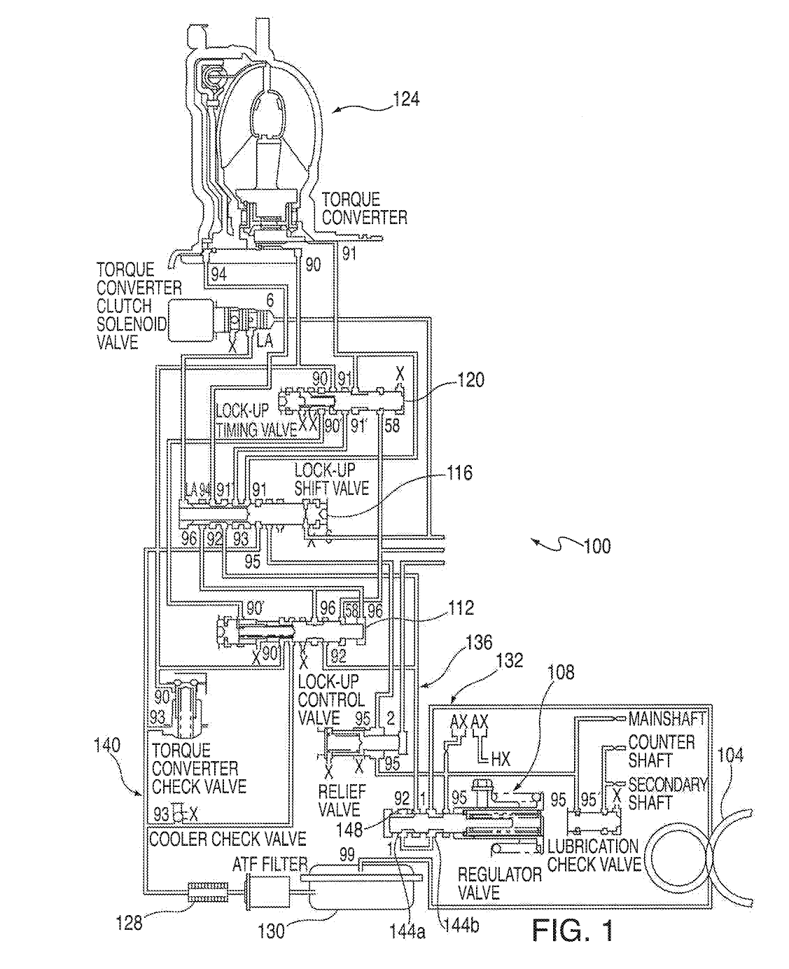

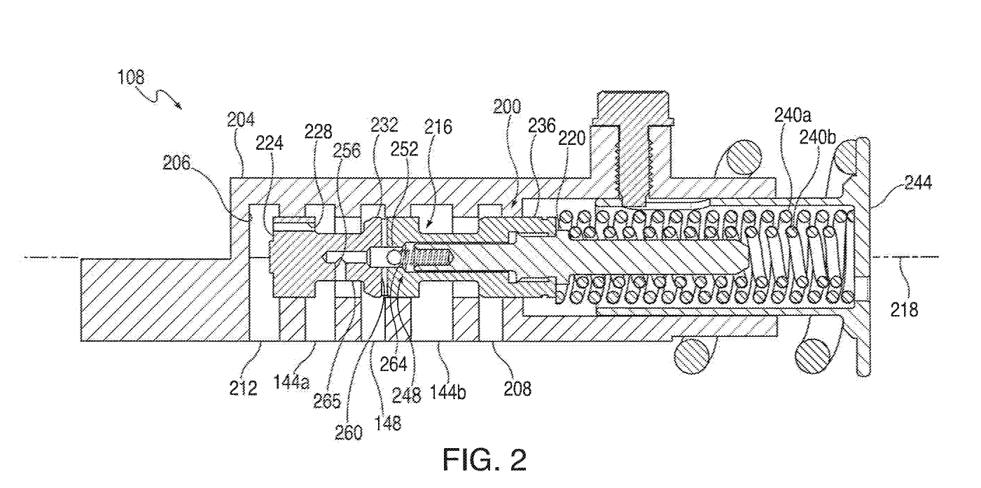

Turning now to the figures, FIG. 1 depicts an exemplary transmission fluid circuit sub-system 100 that provides an exemplary context for the discussion that follows. Sub-system 100 includes a transmission fluid pump 104, a pressure regulator valve 108 that includes valve replacement assembly 200 (not shown in FIG. 1, but described below in the context of FIG. 2), a lock-up control valve 112, a lock-up shift valve 116, a lock-up timing valve 120, a torque converter 124, a transmission fluid cooler 128, and a transmission fluid reservoir 130.

Fluid communication between the aforementioned components may be through, for example, an input fluid circuit 132, a torque converter fluid circuit 136, and a transmission fluid cooler circuit 140. For example, transmission fluid is delivered from transmission fluid reservoir 130 to pressure regulator valve 108 through input fluid circuit 132. From input fluid circuit 132, transmission fluid may be delivered to torque converter 124, and lock-up clutch (not shown) through torque converter fluid circuit 136 and/or delivered to transmission fluid cooler 128 through fluid cooler circuit 140. Those skilled in the art will appreciate that these particular elements and fluid circuits are discussed here for the convenience of describing the examples of the present disclosure, and that the examples herein may be applied to other systems employing a pressure regulator valve and replacement assembly.

In transmission fluid circuit sub-system 100, fluid pump 104 may be a positive displacement pump that supplies a pre-determined amount of transmission fluid from transmission fluid reservoir 130 to input fluid circuit 132 at each cycle of the pump. As mentioned above, depending on the amount of transmission fluid already in sub-system 100, supplying a pre-determined amount of transmission fluid to the sub-system through input fluid circuit 132 may cause the fluid in the sub-system to become over-pressurized, thereby damaging the components of the sub-system. Those skilled in the art will appreciate that this type of damaging pressure may occur in a variety of fluid circuit configurations used in a variety of applications, and not merely those disclosed herein.

In order to reduce the risk of damaging over-pressure of the transmission fluid, input fluid circuit 132 is connected to pressure regulator valve 108, which may regulate the pressure of transmission fluid delivered to other fluid circuits. Pressure regulator valve 108 receives transmission fluid from input fluid circuit 132 through input ports 144a and 144b. As discussed below, pressure regulator valve 108 may divert excess transmission fluid to transmission fluid reservoir 130, thereby maintaining a non-damaging pressure of the transmission fluid within sub-system 100. Transmission fluid that is not diverted to reservoir 130 may then be channeled by pressure regulator valve 108 to torque converter fluid circuit 136 and fluid cooler circuit 140 through output port 148.

### Valve Replacement Assembly

FIG. 2 depicts elements of valve replacement assembly 200, among other elements, used to improve performance of pressure regulator valve 108. In the example shown in FIG. 2, pressure regulator valve replacement assembly 200 is housed by valve body 204. Valve body 204 includes a longitudinal bore 206, input ports 144a and 144b, output port 148, a reservoir exhaust port 208, and a balance port 212. Bore 206 is in fluid communication with input ports 144a and 144b, output port 148, reservoir exhaust port 208, and balance port 212. Valve replacement assembly 200 includes a piston body 216 coupled to a valve stem 220. As discussed more below, valve replacement assembly 200 is sized for reciprocal movement in bore 206 in valve body 204 along longitudinal axis 218. Piston body 216 includes a first terminal control diameter 224 having a duct 228 extending therethrough, an intermediate control diameter 232, the details of which are discussed below, and a second terminal control diameter 236. Second terminal control diameter 236 and valve stem 220 are in operative communication with main pressure regulator springs 240a and 240b that may be biased by a stator arm plunger 244 exerting a force in proportion to the torque transmitted by torque converter 124.

Piston body 216 has a valve chamber 248. Valve chamber 248 includes a check ball 252 that is disposed within the valve chamber. In fluid communication with valve chamber 248 is a bypass input duct 256, a bypass output duct 260 in fluid communication with the bypass input duct, and a check ball spring 264. Bypass input duct 256 is in fluid communication with exterior surface 265 of piston body 216 and bypass output duct 260 is also in fluid communication with the exterior surface. The interaction of these elements of valve replacement assembly 200 is discussed below in the context of three transmission fluid pressure regimes: operating pressure, low pressure, and no pressure.

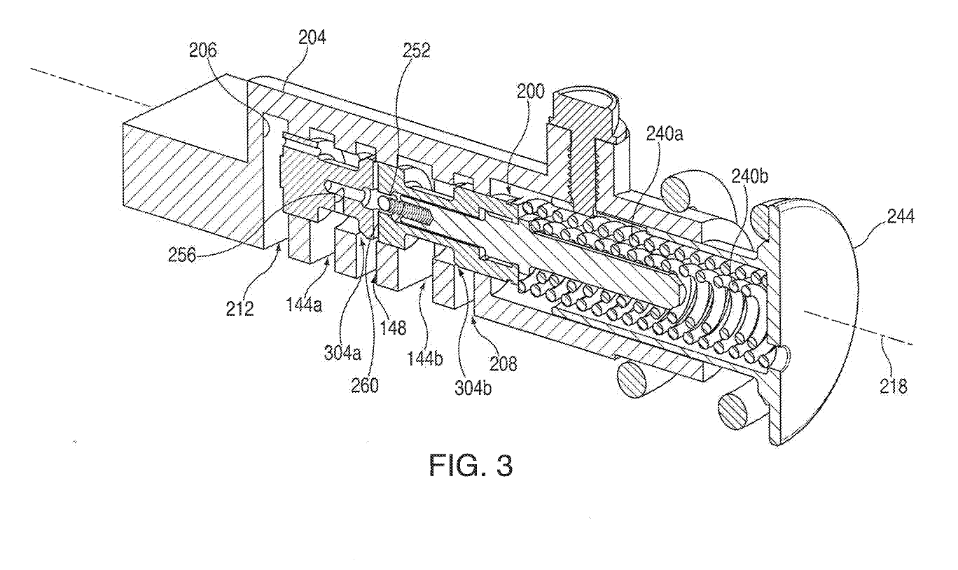

FIG. 2, and also FIG. 3, depict an embodiment of pressure regulator valve replacement assembly 200 as used with pressure regulator valve 108 when transmission fluid is provided to the regulator valve at an operating pressure of the transmission. For the particular application illustrated, the operating pressure is approximately in the range of 50 psi to 150 psi, although those although those skilled in the art will appreciate that these values will differ depending on the particular application employing a pressure regulator valve and a replacement assembly embodying the broad teachings of the present disclosure.

In the example shown, a portion of the transmission fluid provided at a pressure exceeding a predetermined operating pressure is diverted by pressure regulator valve 108 from input fluid circuit 132 to fluid reservoir 130, thereby reducing the volume, and therefore the pressure, of transmission fluid delivered to the fluid circuits. In this way, pressure regulator valve 108 contributes to preventing damage to the components of sub-system 100.

In addition to preventing damage, one advantage of valve replacement assembly 200 when used in pressure regulator valve 108 is that it can maintain a flow of transmission fluid from input fluid circuit 132 to other fluid circuits, even at low transmission fluid pressures caused by low torque transmission of torque converter 124. In this example, low transmission fluid pressures are those that are insufficient to translate valve replacement assembly 200 within valve body 204. In the embodiment depicted in FIG. 2, this pressure is below approximately 100 psi, although those skilled in the art will appreciate that pressures sufficiently low to cause pressure regulator valve 108 to prevent flow of transmission fluid through sub-system 108 will depend on the design and extent of wear of the transmission and its components.

One reason that maintaining transmission fluid flow to the components of sub-system 100 even at low pressures is advantageous is that it enables actuation of lock-up clutch control valve 112, lock-up shift valve 116, and lock-up clutch timing valve 120. Providing these components with fluid permits lock-up clutch 112 to be disengaged. In some examples of pressure regulator valves in the prior art, these components are deprived of transmission fluid at low pressures, preventing disengagement of the lock-up clutch from the torque converter causing the engine to stall at low torque values transmitted by the torque converter. Furthermore, valve replacement assembly 200 may maintain fluid communication between input fluid circuit 132 and transmission fluid cooler circuit 140 at low fluid pressures, thereby reducing the risk of sub-system 100 overheating when torque converter 124 is transmitting low torque.

### Configuration of a Valve Replacement Assembly at an Operating Pressure

In the example depicted in FIGS. 2 and 3, pressure regulator valve 108 channels transmission fluid to selected ports in valve body 204, and therefore selected fluid circuits in fluid communication with the selected ports, depending, in part, on the location of valve replacement assembly 200 within the valve body. The location along longitudinal axis 218 of valve replacement assembly 200 within valve body 204 is a function of two directionally-opposed forces acting on the replacement assembly: the force from the transmission fluid input pressure and the opposing force from main pressure regulator springs 240a and 240b as biased by stator arm plunger 244.

In one embodiment of the above example, transmission fluid is delivered to piston body 216 through input ports 144a and 144b from input fluid circuit 132. Because ports 144a and 144b are approximately symmetric, the forces exerted on piston body 216 at these locations by the transmission fluid have approximately equal and opposing force-components that typically do not substantially translate the piston body in any single direction. In order to translate piston body 216 in a desired direction, an additional force may be applied to the piston body by channeling transmission fluid from input port 144a through duct 228 into balance port 212. The pressurized transmission fluid in balance port 212, exerting an asymmetric force on first terminal control diameter 224, may then translate valve replacement assembly 200 along longitudinal axis 218 toward stator arm plunger 244 (i.e., to the right in FIGS. 2 and 3). The force provided by the fluid is proportional to the torque transmitted by torque converter 124. That is, the more torque that torque converter 124 transmits, the higher the pressure of the transmission fluid provided to balance port 212, and the greater the force exerted on first terminal control diameter 224.

Opposing the force exerted on first terminal control diameter 224 is a force provided by main pressure regulator springs 240a and 240b, as biased by stator arm plunger 244. In this example, main pressure regulator springs 240a and 240b act on second terminal control diameter 236 and valve stem 220. Those skilled in the art will appreciate that in some cases only one of main pressure regulator springs 240a and 240b may be needed to produce an adequate force. Analogous to the force provided at first terminal control diameter 224, the bias provided by stator arm plunger 244 is in proportion to the torque transmitted by torque converter 124. That is, the more torque that torque converter 124 transmits, the more bias stator arm plunger 244 provides to main pressure regulator springs 240a and 240b.

As mentioned above, both the force supplied by the pressurized transmission fluid and the force supplied by stator arm plunger 244 are proportional to the torque transmitted by torque converter 124. Therefore, because of this relationship, main pressure regulator springs 240a and 240b may be selected to have spring constants such that, over a range of force values, the forces are balanced so that control diameters 220, 232, and 236 are positioned with respect to ports 144a, 144b, 148, and 208 in order to channel transmission fluid into desired ports or, alternatively, to prevent fluid flow into select ports. In the example depicted in FIGS. 2 and 3, main pressure regulator springs 240a and 240b may have spring constants approximately in the range of 10 lbs/in to 40 lbs/in and 50 lbs/in to 150 lbs/in, respectively, although those skilled in the art will appreciate that these values may vary according to the specifics of the application.

Continuing with the present example, in FIG. 2, valve replacement assembly 200 is in a regulating position within valve body 204 responsive to transmission fluid having a non-zero input pressure. In this example, the input pressure can be approximately in the range of 75 psi to 150 psi. For the reasons discussed above, the example in FIG. 2 also depicts a position corresponding to a bias force supplied by stator arm plunger 244 to main pressure regulator springs 240a and 240b. Because the spring constants of main pressure regulator springs 240a and 240b have been selected in the manner described above, valve replacement assembly 200 is aligned with valve body 204 such that input fluid circuit 132 is in fluid communication with torque converter fluid circuit 136 and fluid cooler circuit 140.

Specifically, referring to FIG. 3, input port 144a is in fluid communication with output port 148 at gap 304a and input port 144b is in fluid communication with reservoir exhaust port 208 at gap 304b. Gap 304a permits transmission fluid to flow into torque converter fluid circuit 136 and fluid cooler circuit 140 from input fluid circuit 132. Gap 304b permits excess transmission fluid to flow from input fluid circuit 132 into fluid reservoir 130 through reservoir exhaust port 208, thereby maintaining an appropriate transmission fluid pressure within sub-system 100. Because valve replacement assembly 200 is in a dynamic equilibrium with stator arm plunger 244 through main pressure regulator springs 240a and 240b, valve replacement assembly 200 will slide back and forth along longitudinal axis 218 within valve body 204 as the fluid pressure from input fluid circuit 132 increases and decreases, thereby opening and closing output port 148 and exhaust port 208 as needed to maintain appropriate fluid pressure within the fluid circuits of sub-system 100.

Additionally, transmission fluid also flows from port 144a into output port 148 through gap 304a, bypass input duct 256, and bypass output duct 260. This particular path of fluid communication is maintained regardless of the axial position of valve replacement assembly 200 within valve body 204 and, rather, is a function of the position of a check ball 252 within valve chamber 248. The function of this aspect of valve replacement assembly 200 is discussed in more detail below for cases of low transmission fluid input pressure.

### Configuration of a Valve Replacement Assembly at a Low Operating Pressure

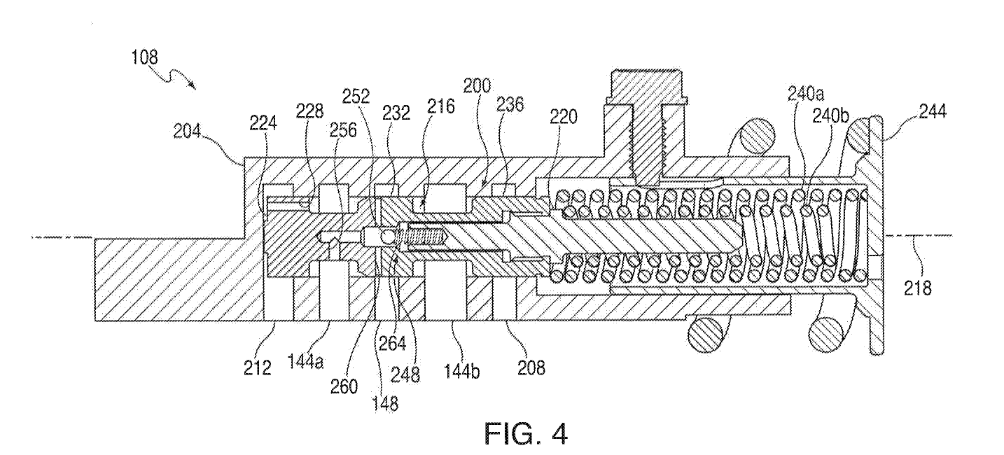

With reference to FIGS. 1 and 4, in the example shown in FIG. 4, input fluid circuit 132 may supply transmission fluid at a low, but non-zero, pressure to output port 148 even though valve replacement assembly 200 is positioned within valve body 204 such that the output port is occluded by intermediate control diameter 232. In this example, a low pressure may be below approximately 75 psi, although those skilled in the art will appreciate that this is partially a function of the valve and transmission design. In this condition, because the fluid pressure is low, little or no transmission fluid flows into input port 144a, and therefore little or no fluid flows through duct 228, and thence into balance port 212. As such, the force exerted on valve replacement assembly 200 from balance port 212 is insufficient to overcome the counter-acting bias force exerted on the replacement assembly by main pressure regulator springs 240a and 240b. As a result, piston body 216 is positioned within valve body 204 such that first terminal control diameter 224 occludes balance port 212, intermediate control diameter occludes output port 148, and second terminal control diameter occludes reservoir exhaust port 208. This configuration has the effect of preventing transmission fluid from entering torque converter circuit 136 from input port 144a, or draining through reservoir exhaust port 208 from input port 144b. For pressure regulator valves of the prior art, this configuration may cause one or both of two potentially detrimental effects when torque converter 124 is operating at low pressure. These two potentially detrimental effects are explained below, as are advantages provided by valve replacement assembly 200.

The first potentially detrimental effect exhibited by some pressure regulator valves is sub-system 100 overheating caused by low transmission fluid pressures. As explained above and illustrated by FIG. 4, when the transmission fluid is at a low pressure, for example when torque converter 124 is transmitting low values of torque, valve replacement assembly 200 is configured so that output port 148 is occluded. This in turn deprives transmission fluid cooler circuit 140 of fluid to be cooled, which causes overheating. The second potentially detrimental effect is that, because output port 148 is occluded, lock-up control valve 112, lock-up shift valve 116, and lock-up timing valve 120 are deprived of transmission fluid. This deprivation may prevent the lock-up clutch (not shown) from disengaging, thereby stalling the engine.

These two detrimental effects may be avoided by using valve replacement assembly 200 in valve body 204. For example, as shown in FIG. 4, valve replacement assembly 200 may maintain the flow of transmission fluid to output port 148 even at low torque levels transmitted by torque converter 124 because of the alternate fluid route from input port 144a through bypass input duct 256, valve chamber 248, and out bypass output duct 260. From output port 148 the transmission fluid may supply transmission fluid cooler circuit 140, thereby maintaining cooling for sub-system 100, and torque converter fluid circuit 136, thereby enabling lock-up clutch to engage and/or disengage through the coordinated action of lock-up control valve 112, lock-up shift valve 116, and lock-up timing valve 120. Furthermore, because check ball spring 264 within valve chamber 248 has a low spring constant, approximately in the range of 1 lb/in to 3 lbs/in, even very low pressure transmission fluid entering the valve chamber through input ports 144a and 144b may force check ball 252 to compress the check ball spring, thereby placing bypass input duct 256 in fluid communication with output port 148.

### Configuration of a Valve Replacement Assembly at Approximately Zero Operating Pressure

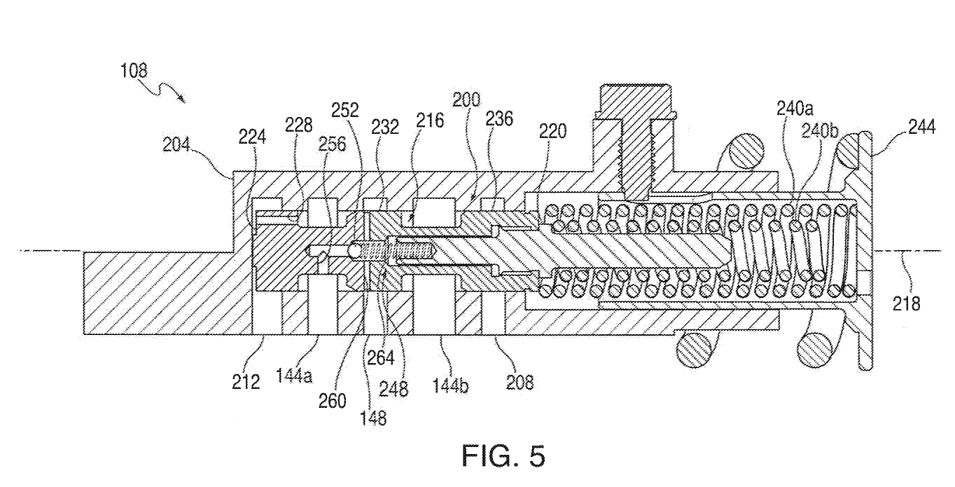

FIG. 5 illustrates the configuration of valve replacement assembly 200 within valve body 204 in which the transmission fluid is substantially not pressurized. This condition may occur, for example, when the engine is turned off, thereby deactivating transmission fluid pump 104. In this case, check ball spring 264 exerts a force on check ball 252 so that the check ball occludes bypass input duct 256 at its confluence with valve chamber 248. This occlusion inhibits fluid communication between bypass input duct 256 and output port 148 and prevents transmission fluid from draining out of the fluid circuits through pressure regulator valve 108 when the vehicle is not operating. Because some transmission fluid remains in the fluid circuits, the components requiring transmission fluid to operate, for example the torque converter, may operate as intended even at start-up.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A pressure regulator valve assembly for maintaining a flow of automatic transmission fluid from an input fluid circuit to a torque converter fluid circuit and a transmission cooling fluid circuit of Honda Transmissions during low torque operation of a torque converter, the Honda Transmissions including a bore in fluid communication with the input fluid circuit, the torque converter fluid circuit and the transmission cooling fluid circuit, said pressure regulator valve assembly comprising:
a valve piston subassembly receivable in the bore in the transmission, said valve piston subassembly including a piston body coupled to a valve stem, said piston body having two terminal control diameters and at least one intermediate control diameter disposed between said two terminal control diameters, said at least one intermediate control diameter having an exterior surface in fluid communication with the bore when positioned in the bore, said valve piston subassembly including a valve chamber positioned substantially within said intermediate control diameter and configured to extend to said exterior surface so as to be in fluid communication with (i) said exterior surface and (ii) the bore when said valve piston subassembly is positioned in the bore; and
a check ball disposed within said valve chamber so as to be movable between (i) a first position where said check ball is located so that said valve chamber is in fluid communication with the bore and hence the input circuit, the torque converter circuit, and the cooling circuit when the valve piston subassembly is positioned in the bore so that the automatic transmission fluid may be channeled from the input circuit to the torque converter circuit via said valve chamber and (ii) a second position where said check ball is located to occlude said valve chamber such that said valve chamber is not in fluid communication with the input circuit, whereby automatic transmission fluid is not channeled from the input circuit to the torque converter circuit.

2. A pressure regulator valve assembly according to claim 1, wherein the Honda Transmissions include a torque converter stator arm, the position of which varies as a function of the torque transferred from the torque converter, wherein the pressure regulator valve assembly further includes a stator plunger and at least one main pressure regulator spring in operative communication with said stator plunger, said main pressure regulator spring disposed between said stator arm plunger and said pressure regulator valve assembly so that said stator arm plunger may provide a biasing force to said at least one main pressure regulator spring in proportion to the amount of torque transferred from the torque converter through the torque converter stator to said stator arm plunger when the pressure regulator valve assembly is positioned so that the stator plunger is in contact with the torque converter stator.

3. A pressure regulator valve assembly according to claim 2, wherein said at least one main pressure regulator spring has a spring constant approximately in the range of 10 pounds per inch to 30 pounds per inch.

4. A pressure regulator valve assembly according to claim 1, further including a check ball spring in operative communication with said check ball.

5. A pressure regulator valve assembly according to claim 4, wherein said check ball spring has a spring constant approximately in the range of 1 pound per inch to 3 pounds per inch.

6. A Honda Transmission modified to maintain a flow of automatic transmission fluid from an input fluid circuit to a torque converter fluid circuit and a transmission cooling fluid circuit during low torque operation of a torque converter, said Honda Transmission comprising:
a bore;
a pressure regulator assembly including:
(i) a valve piston subassembly received in the bore in the transmission, said valve piston subassembly including a piston body coupled to a valve stem, said piston body having two terminal control diameters and at least one intermediate control diameter disposed between said two terminal control diameters, said at least one intermediate control diameter having an exterior surface in fluid communication with said bore, said valve piston subassembly including a valve chamber positioned substantially within said intermediate control diameter and configured to extend to said exterior surface so as to be in fluid communication with (i) said exterior surface and (ii) said bore; and
(ii) a check ball disposed within said valve chamber so as to be movable between (i) a first position where said check ball is located so that said valve chamber is in fluid communication with the bore and hence the input circuit, the torque converter circuit, and the cooling circuit when the valve piston subassembly is positioned in the bore so that the automatic transmission fluid may be channeled from the input circuit to the torque converter circuit via said valve chamber and (ii) a second position where said check ball is located to occlude said valve chamber such that said valve chamber is not in fluid communication with the input circuit, whereby automatic transmission fluid is not channeled from the input circuit to the torque converter circuit.

7. A Honda Transmission according to claim 6, wherein the Honda Transmission includes a torque converter stator arm, the position of which varies as a function of the torque transferred from the torque converter, wherein the pressure regulator valve assembly further includes a stator plunger and at least one main pressure regulator spring in operative communication with said stator plunger, said main pressure regulator spring disposed between said stator arm plunger and said pressure regulator valve assembly so that said stator arm plunger may provide a biasing force to said at least one main pressure regulator spring in proportion to the amount of torque transferred from the torque converter through the torque converter stator to said stator arm plunger when the pressure regulator valve assembly is positioned so that the stator plunger is in contact with the torque converter stator.

8. A Honda Transmission according to claim 7, wherein said at least one main pressure regulator spring has a spring constant approximately in the range of 10 pounds per inch to 30 pounds per inch.

9. A Honda Transmission according to claim 6, further including a check ball spring in operative communication with said check ball.

10. A Honda Transmission according to claim 9, wherein said check ball spring has a spring constant approximately in the range of 1 pound per inch to 3 pounds per inch

11. A method of maintaining a flow of transmission fluid from an input fluid circuit to a torque converter fluid circuit and a transmission cooling fluid circuit of a Honda Transmission during low torque operation of a torque converter of the Honda Transmission, the method comprising:
providing a valve piston subassembly receivable in a regulator valve bore in the Honda Transmission, the valve piston subassembly including a piston body having two terminal control diameters and at least one intermediate control diameter disposed between the two terminal control diameters, the at least one intermediate control diameter having an exterior surface, the valve piston subassembly including a valve chamber positioned substantially within the intermediate control diameter and configured to extend to the exterior surface so as to be in fluid communication with (i) the exterior surface and (ii) the bore when said valve piston subassembly is positioned in the bore, the valve chamber including a check ball biased by a spring; and
channeling the transmission fluid from the input fluid circuit to the torque converter fluid circuit and the cooling fluid circuit during low torque operation of the torque converter through the valve chamber positioned substantially within the intermediate control diameter, the transmission fluid from the input fluid circuit being provided at sufficient pressure to overcome the bias force from the spring on the check ball.

12. A method according to claim 11, wherein said channeling includes biasing the valve piston subassembly using a torque converter stator arm in operative communication with a stator plunger and at least one main pressure regulator spring in operative communication with the stator plunger, the main pressure regulator spring disposed between the stator arm plunger and the valve piston subassembly so that the stator arm plunger may provide a biasing force to the at least one main pressure regulator spring in proportion to the amount of torque transferred from the torque converter through the torque converter stator to the stator arm.

13. A method according to claim 12, wherein said biasing includes moving the valve piston subassembly under spring bias within the bore during low torque operation of the torque converter so as to prevent fluid communication between the input fluid circuit, the torque converter fluid circuit and the cooling fluid circuit.

14. A method according to claim 11, further comprising preventing the transmission fluid from draining from the torque converter fluid circuit and the cooling fluid circuit into a transmission fluid sump when the torque converter is not operating by (i) positioning the valve piston subassembly within the bore so as to prevent fluid communication between the input fluid circuit and the torque converter fluid circuit and the transmission cooling fluid circuit and (ii) biasing the check ball with the spring so as to prevent fluid communication between the fluid circuits through the valve chamber.
